(19) United States
(12) Patent Application Publication
(10) Pub. No.: US 2011/0047038 A1
(43) Pub. Date: Feb. 24, 2011

(54) Smart Card For Safer Credit Transactions

(76) Inventor: Uri Halevi, Modi'in Ilit (IL)

Correspondence Address: The Law Office of Michael E. Kondoudis, 888 16th Street, N.W., Suite 800, Washington, DC, 20006, US

(21) Appl. No.: 12/937,830

(22) PCT Filed: Apr. 16, 2009
(86) PCT No.: PCT/IL09/00412

§ 371 Date: Oct. 14, 2010

(30) Foreign Application Priority Data
Apr. 17, 2008 (IL) 190986

(51) Int. Cl. G06Q 20/00; G06K 19/073

(52) U.S. Cl. 705/17; 235/492; 235/380

(57) ABSTRACT

A smart credit card device for allowing its owner to safely make credit transactions, which comprises a display screen; a memory for storing permanent data of the device and its owner and unique temporary dat regarding an impending specific transaction; a wireless transceiver for being in data communication with the credit company through a point o sale; input components for allowing the owner to input data essential fo performing the transactions; a processor for controlling the operation o the card device; and a power source such as a battery or a solar cell arra with a backup battery for supplying DC power to the card device.

### FIELD OF THE INVENTION

The present invention relates in general to the field of electronic protection systems. More particularly, the present invention relates to a smart credit card for making secure transactions.

### BACKGROUND OF THE INVENTION

Credit card fraud is problematic all over the world. The credit card companies try to deal with this problem in several ways. Inside the credit card companies, there are professional people who analyze credit card frauds. The credit card companies do not want these frauds to be publicized.

There are thieves that photograph the number of the credit card (for instance taking pictures with there cell phones), and use this information to fraud. In addition, the card number is exposed to every store owner, every business proprietor and every cashier, which can easily purchase by phone or by internet using this number. Needless to say that having a credit card is not very reassuring.

US Application No. 20020013904 describes a method of authenticating users of controlled systems by providing for each registered user of the system to be required to produce an access code which varies for each user and for each occasion of use, by means of an account number, conventional fixed personal identification number and a random code grid matrix with embedded alphanumeric codes, in a preferred embodiment related to each weekday, date and month. The correct unique authentication code for any occasion for any registered user is known to a master computer system but may be produced by the registered user in a variety of ways, both online or in another interactive system and also directly from the code card without interactivity with the master system. The codes are randomly generated and therefore cannot be predicted as no pattern exists. Moreover, the order in which elements of the codes are required to be input is also randomly generated, during the authentication process itself for an interactive system, to produce secure remote authentication for any controlled system including online or network system access and especially payment card systems and transactions. This application does not specify the device capable of executing the features mentioned.

KR20030033888 describes a credit card capable of executing a user authentication. It is provided to authenticate the identity of a credit card user without replacing or upgrading a currently used credit card reader. This is implemented by putting a password using an input unit of a credit card of the user and activating information necessary for a payment after checking the inputted password. This card need an extra keypad to be attached to the thin card main body for inputting a password of a user and setting a function fitting for the card, what makes the proposed solution a bit cumbersome.

It is therefore an object of the present invention to provide a safe smart compact credit card device to prevent from committing a credit card fraud.

It is a further object of the present invention to provide a method for using a credit card more safely.

It is a further object of the present invention to provide a credit card which is smart and compact.

Additional objects and advantages of the present invention will become apparent as the description proceeds.

### SUMMARY OF THE INVENTION

The present invention is directed to a smart credit card device for allowing its owner to safely make credit transactions, which comprises
a) a display screen;
b) a memory for storing permanent data of the device and its owner and unique temporary data regarding an impending specific transaction;
c) a wireless transceiver for being in data communication with the credit company through a point of sale;
d) one or more input components for allowing the owner to input data essential for performing the transactions;
e) a processor for controlling the operation of the card device; and
f) a power source such as a battery or a solar cell array with a backup battery for supplying DC power to the card device.

The device may further comprise a magnetic strip attached to the card, being capable of providing the unique temporary data to a credit card reader.

The device may further comprise a chip being in a remote connection with an additional unit chip, for alerting whenever the two chips are distanced more than a predetermined distance.

The device may further comprise a communication port, such as USB for transferring purchasing data from its memory to another device.

The present invention is also directed to a method for performing safe credit card transactions, comprising:
a) prior to making a purchase, the credit card device owner punches in a master code number;
b) sending a request to the credit card company to send back a randomly produced temporary code number to the credit card device;
c) displaying the temporary code number on the device's display screen;
d) at a point of sale (POS), and submitting the displayed temporary code number to the credit card company; and
e) at the credit card company, verifying the submitted temporary code number and charging the credit card.

### BRIEF DESCRIPTION OF THE FIGURES

In the drawings:

FIGS. 1A and 1B illustrate a perspective view of the present invention;

FIG. 2 illustrates a method of communication according to a preferred embodiment of the present invention;

FIG. 3 illustrates a method of communication according to a preferred embodiment of the present invention;

FIG. 4 illustrates a method of communication according to a preferred embodiment of the present invention; and

FIG. 5 illustrates a method of communication according to a preferred embodiment of the present invention.

### DETAILED DESCRIPTION OF THE PREFERRED EMBODIMENTS

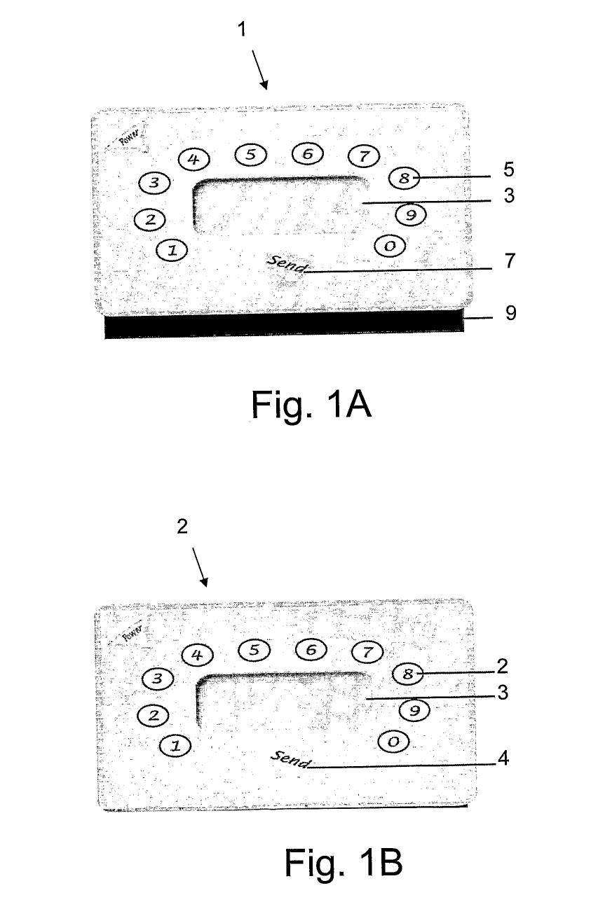

The present invention is related to a smart credit card device (1) with a unique code system, as illustrated in FIG. 1A. This code system makes it difficult for a thief to commit a credit card fraud.

The smart credit card device (1) comprises a display screen (3), for displaying a temporary code as described herein, a memory for saving permanent data regarding the device and temporary data as described herein, a wireless transceiver for communication as described herein, a processor and a power source. The card device (1) is a thin card with the area of a conventional credit card. The card device further comprises an array of solar cells from where it gains its power. First the card device (1) will consume its power from the solar cell array. Then if required it will consume its power from a battery.

Prior to making a purchase, the credit card device owner must punch in a permanent master code number (permanently saved on the devices memory) on the appropriate number buttons (5) and press a send button (7) on the card device (1), sending a request (in a way that will be explained further on in the specification) to the credit card company's program to send back a randomly produced temporary code number herein known as a temporary code number, to the credit card device (1). The temporary code number will appear on the device's display screen (3). The cashier's reader reads the credit card's details and the cashier types and submits the temporary code number that shows up on the card device display screen (3), thereby approving the transaction. If the temporary code number is not submitted the system will intercept the user's credit account and will not allow transaction.

After the transaction, the temporary code number will be erased from the system and of no more value as to another purchase. The next time the user desires to make a purchase, he must again type in the master code number on the card device (1), send it and will receive a new temporary code number for the next transaction. Using this system, even if a thief would see the card number he would not be able to purchase with this number at all, not knowing the master code number in order to receive a temporary code number.

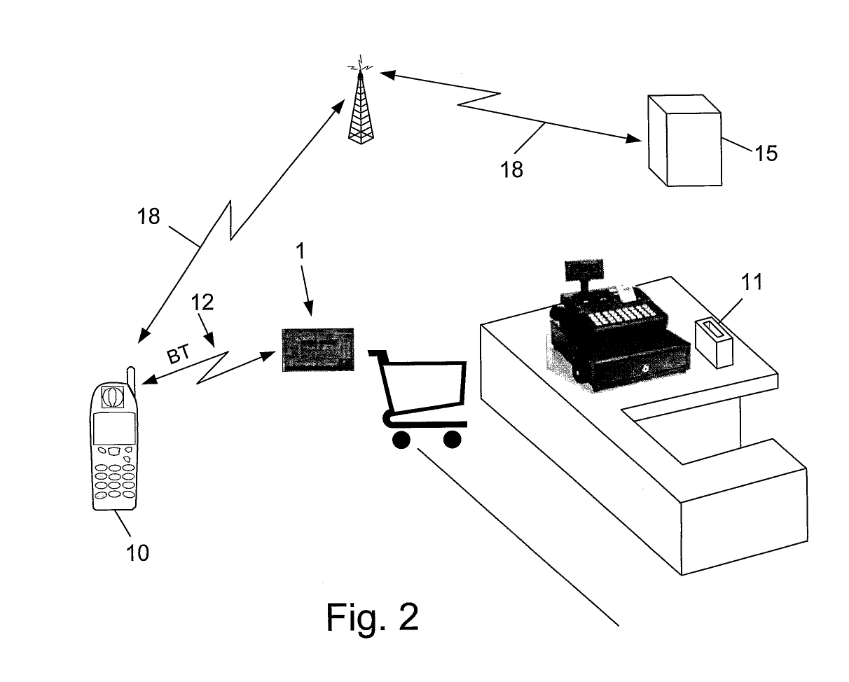

In a preferred embodiment of the present invention, the card device comprises a magnetic strip (9), shown in FIG. 1, which sticks out of the electronic card device (1), and is compatible to go through the cashier's credit card slit (11), shown in FIG. 2. The cashier charges the device owner by sliding the magnetic strip (9) through the credit card slit (11) as is done during a standard transaction, only the cashier must also submit the temporary code number received to allow the transaction.

In another embodiment of the present invention purchasing can be accomplished with a card device (2) which does not comprise a magnetic strip, as shown in FIG. 1B. The card owner can make a purchase by receiving a temporary code number from the credit card company as explained herein, and deliver the serial number of the card to the cashier along with the temporary code number to enable transaction. The same method can be used for buying merchandise by phone, on the internet, or by any other method of purchase that requires submission of the serial number of the card. It should be emphasized that this method of purchasing by delivering the serial number of card device (2) to the cashier, can also be implemented using card device (1).

In a preferred embodiment of the present invention, the card device transceiver uses a Bluetooth system, as illustrated in FIG. 2. The card device (1) communicates from a short distance with a long distance communication device, for instance the user's cell phone (10). The card device (1) sends a request for a temporary code number after the user types in the master code number. This information is delivered by a Bluetooth communication system (12), from a short distance of about 10 meters, to the cell phone (10). The cell phone (10) delivers the data to the credit card company (15) by using a cellular network (18). The credit card company (15) sends back to the cell phone, by the same cellular network (18), a temporary code number. The cell phone sends it to the card device (1) by the Bluetooth communication system (12). The code number is shown on the card device's display screen thus making the card device ready for purchasing.

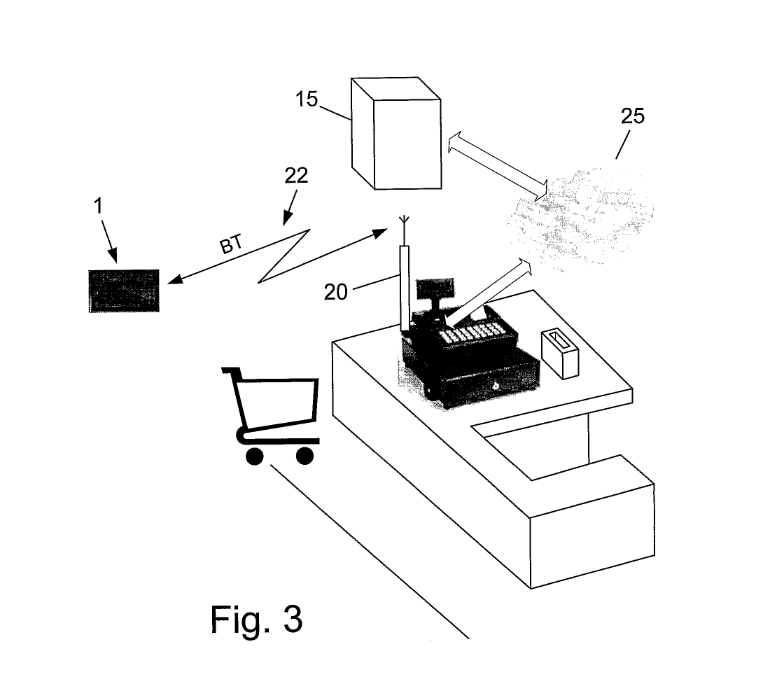

In another preferred embodiment of the present invention, there is a Bluetooth transceiver (20) at every cash register, as shown in FIG. 3. The transceiver (20) will receive the data (the master code number) from the card device (1) using a Bluetooth system (22), and will communicate with the credit card company (15) not by cellular phone but by other means (25) for example by an internet server or by a telephonic wire line using a modem or through another server. The temporary code number received from the credit card company (15) will return the same way back to the transceiver (20) and from the transceiver (20) by the Bluetooth system (22) to the card device (1). The code number will be shown on the card device's display screen and the card device (1) will be ready for purchasing.

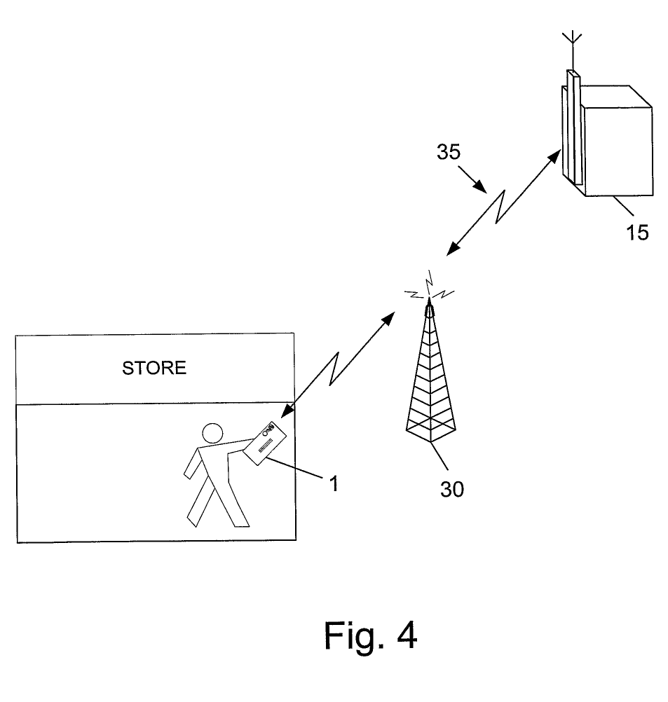

In another preferred embodiment of the present invention, the system is based on a WiMAX systems as shown in FIG. 4. A hotpoint antenna (30) is placed at a nearby location. The data is delivered from the card device (1) to the nearby antenna (30) and from the antenna (30) to the credit card company (15) by use of a WiMAX communication system (35). The return data is also returned the same way i.e. data (temporary code) by WiMAX system (35) to the antenna (30) and from the antenna to the card device (1). The code number will be shown on the card device's display screen and the card device (1) will be ready for purchasing.

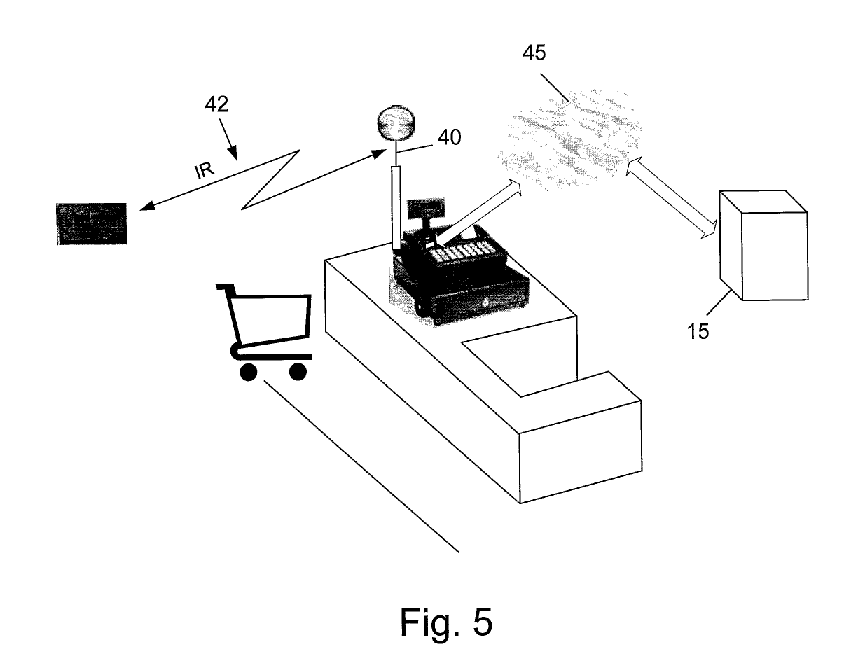

In another embodiment of the present invention the system is based on an infrared (IR) system as shown in FIG. 5. The “last mile” communication technique is based on the infrared system. The data (master code number) from the card device is transmitted by an infrared signal (42) to a central antenna (40) in the store preferably near the cashier. In order to deliver the data from the IR antenna (40) to the credit card company (15) the system can use several means (45), for example a cellular phone system or an Internet server or a telephonic wire line using a modem or WIFI or WiMAX or another RF system. The data transmitted from the credit card company (15) back to the antenna (40) is by the same technique as it was delivered. Transmission from the antenna (40) to the card device (1) is by an infrared signal. The code number will be shown on the card device's display screen and the card device will be ready for purchasing.

In another preferred embodiment of the present invention, the card device owner can send a request for a temporary code number using the communication system that the cashier uses to send standard credit card data to the credit card company (usually being sent automatically from the magnetic reader). The card device owner can transmit the master code to the cashier's system by means of methods described herein for example, using Bluetooth transceiver. Then the cashier's system sends the data to the credit card company. Transmission from the cashier's system to the credit card company can be based on a phone wire line, Internet or any other methods of long distance transmission mentioned herein. The temporary code sent back from the credit card company can be returned the same way it was sent.

In another embodiment of the present invention, the user can press a button that transmits the temporary code (obtained earlier) directly to the cash register's system (to be sent to the credit card company) instead of the cashier typing it into the system. This can prevent typing errors that could be made by the cashier. Transmission of the temporary code number to the cash register's system can be done by any of the methods mentioned herein.

In a preferred embodiment of the present invention, the user has the possibility to upload in advance 3 temporary code numbers on the card device for 3 purchases. The user can limit each of these purchases to a certain sum. He may want to do so in order to give the card device to one of his children to perform a few limited purchases. When the numbers are loaded on the card device the display screen will show the temporary code number of the next coming purchase. After a purchase is made the temporary number will be deleted and the next temporary number will appear on the card device's display screen. The user can decide whether to limit each purchase to a certain date or to enable a purchase only after a certain time from the previous purchase. It should be noted that the user uploads the temporary code numbers and he does not need to disclose the master code to the point of sale. The master code is needed only for uploading the temporary codes. After the temporary codes are uploaded, transaction is made with the submission of the temporary only.

The user can give the card to who ever he wants and trusts for making a safe transaction. Using the present invention, a buyer can make a purchase without needing to sign a receipt. It is safe enough without needing a verification signature.

In another embodiment of the present invention, a chip can be installed in the card device. The chip will have a remote connection to another chip which will be installed in the owner's wallet, purse or pocket etc. The card device chip will beep when the card device is distanced a certain distance from the owner. The distance could be decided and programmed according to the will of the credit card company. The beeping of the card device may indicate theft of the card device or forgetting it somewhere. If the card continues to beep and is not retrieved within the amount of time programmed according to the will of the company, the card shall be disabled until contact with the company and verification is made or until the card device is once again united with the chip.

In another embodiment of the present invention, the features of the card device can be installed in a cell phone or other mobile devices such as a PDA etc. The user can use the installed card with the same options, features and methods as if it were a standard physical card device.

In another embodiment of the present invention, the request for a temporary code number can be done by telephone, SMS, cellular phone, or by another way of communication, verbally or visually. The credit card company then sends a temporary code number to the card device as explained herein.

In another embodiment of the present invention, the card device will have installed memory that will save all the purchase information (price, store, date, etc.). The card device can be connected with a USB to a computer and the owner of the card device can print out a list of his purchases.

In another embodiment of the present invention, when the wrong master code is entered and sent more than a specific amount of times programmed according to the desire of the credit card company, the card device will be automatically blocked and no more purchases can be made until the user contacts the credit card company and reactivates his system.

In another embodiment of the present invention, it is possible to make the card device owner type on the device card the sum of the purchase he wishes to make along with the master code number transmitting them to the credit card company, thus receiving the temporary code and enabling transaction for this purchase only for the amount of the sum transmitted. This can prevent being charged for a sum larger than the sum that the credit card device owner had in mind, for the current purchase.

In another embodiment of the present invention it is possible to make the code typing process more complex in order to further provide more protection to the system. For instance two or three presses on the first master code number, one press on the next number, four presses on the third number and two presses on the fourth. This makes it very difficult for a thief to see the correct typing of the master code.

In another embodiment of the present invention the card device (2) comprises additional buttons such that each additional button represents a different credit card company. This enables the card device owner to have several credit card accounts in one device. If the owner wants he can make a purchase using a certain account. If he presses on a button which represents a different credit card company the purchase will be done using the account of the credit card company that was pressed.

In another embodiment of the present invention, the device comprises an additional button such that when the additional button is pressed a request is sent to the credit card company for sending back the balance of the user's credit card account. The balance amount is sent back from the credit card company to the card device and can be viewed on the card device's display screen. Means of communication for this request, from the card device to the credit card company and back, are the same means as described herein.

In another embodiment of the present invention, purchasing can be accomplished in a standing order fashion. The card device owner requests a temporary code number as described herein, and after submitting the temporary code, the system enables transaction. The system enables a specific charging company to collect a different sum each month (or other pre-defined period of time) depending on the amount of money that the company charges for that specific month (or other period of time). For example, an electric company can charge a different amount each month depending on the amount of electricity used. The temporary code number is needed only once in the beginning for starting this process of standing order payments.

According to another embodiment, The card device (1) may be used for helping a user who is forced by a third party (for example a robber) to purchase precious goods (e.g., gemstones) by charging the user's credit against his will, to get help from law enforcement staff. In this case, the user will activate the card device (1) as usual and send a request for a temporary code number after typing the master code number, but in an opposite direction (i.e., typing the last code digit first and the first digit last). This will be a sign to the credit card company that the user is in distress and needs help. This information will delivered by a Bluetooth communication system (12), from a short distance of about 10 meters, to the cell phone (10). The cell phone (10) delivers the data to the credit card company (15) by using a cellular network (18). The credit card company (15) sends back to the cell phone, by the same cellular network (18), a temporary code number. The cell phone sends it to the card device (1) by the Bluetooth communication system (12). The code number is shown on the card device's display screen thus making the card device ready for purchasing. However, since the master code number is fed in the opposite direction the distress condition is identified and the transaction will be denied. In the same time, the credit card company will inform the law enforcement authorities about the user in distress, so as to help him. The location of the user in distress can be determined by the cellular provider according to the data transmitted between the cellular device and the nearest base stations (like is done while providing conventional location based services). Alternatively, if the cellphone has integral GPS the location may be obtained and transmitted immediately.

While some embodiments of the invention have been described by way of illustration, it will be apparent that the invention can be carried into practice with many modifications, variations and adaptations, such as implementing a flat cellular transceiver with a SIM on the smart card for allowing it to communicate independently with the credit card company via cellular networks, and with the use of numerous equivalents or alternative solutions that are within the scope of persons skilled in the art, without departing from the spirit of the invention or exceeding the scope of the claims.

1. A smart credit card device for allowing its owner to safely make credit transactions, which comprises
a) a display screen;
b) a memory for storing permanent data of the device and its owner and unique temporary data regarding an impending specific transaction;
c) a wireless transceiver for being in data communication with the credit company through a point of sale;
d) one or more input components for allowing said owner to input data essential for performing said transaction;
e) a processor for controlling the operation of said card device; and
f) a power source for supplying DC power to said card device.

2. The device according to claim 1, further comprising a magnetic strip attached to the card, being capable of providing the unique temporary data to a credit card reader.

3. The device according to claim 1, wherein the power source is a battery.

4. The device according to claim 1, wherein the power source is a solar cell array with a backup battery.

5. The device according to claim 1, in which a chip is installed being in a remote connection with an additional unit chip, for alerting whenever the two chips are distanced more than a predetermined distance.

6. The device according to claim 1, further comprising a communication port for transferring purchasing data from its memory to another device.

7. The device according to claim 7, wherein the port is compatible with USB.

8. A method for performing safe credit card transactions, comprising:
a) prior to making a purchase, the credit card device owner punches in a master code number;
b) sending a request to the credit card company to send back a randomly produced temporary code number to said credit card device;
c) displaying the temporary code number on the device's display screen
d) at a point of sale (POS), and submitting the displayed temporary code number to said credit card company; and
e) at said credit card company verifying the submitted temporary code number and charging said credit card.

9. A method according to claim 8, wherein charging is executed by passing the magnetic strip through the POS's credit card slit.

10. A method according to claim 8, wherein charging the credit card device is executed telephonically by allowing the POS to submit the serial number of the card device provided by the owner along with the temporary code number.

11. A method according to claim 8, wherein charging the credit card device is done through the internet by allowing the owner to fill in the serial number of the card device and the temporary code number.

12. A method according to claim 8, wherein sending a request for a temporary code and receiving the temporary code is done by:
a) A short distance transmission between the card device and a transceiver unit that can be done by one of the following ways:
1) Transmission is done between the card device and the transceiver unit located at the user's cellular phone by way of Bluetooth.
2) Transmission between the card device and a transceiver unit located at the cash register by way of Bluetooth.
3) Transmission between the card device and a transceiver unit located at a Wimax antenna by way of Wimax technology.
4) Transmission between the card device and a transceiver unit located at a Wifi antenna by way of Wifi technology.
5) Transmission between the card device and a transceiver unit located at a RF antenna by way of RF technology.
6) Transmission between the card device and a transceiver unit located at the cash register by way of an infrared transmission.
b) A long distance transmission that can be done by one of the following ways:
1) Transmission between the owner's cellular device and the credit card device company's network center by way of cellular phone technology.
2) Transmission between the cash register and the credit card device company's network center by way of internet.
3) Transmission between the cash register and the credit card device company's network center by way of a phone wire line.
4) Transmission between the cash register and the credit card device company's network center by way of the communication system that already exists between them.
5) Transmission between a Wifi antenna and the credit card device company's network center by way of Wifi technology.
6) Transmission between a Wimax antenna and the credit card device company's network center by way of Wimax technology.
7) Transmission between an RF antenna and the credit card device company's network center by way of an RF technology.

13. A method according to claim 8, wherein the buyer presses a button that transmits the temporary code number obtained earlier directly to the cash register's system.

14. A method according to claim 8, wherein the buyer pre-uploads 3 temporary code numbers on the card device for 3 purchases, for limiting each purchase to a certain predetermined sum, while the display screen shows the temporary code number of the next purchase.

15. A method according to claim 14, wherein the buyer limits each purchase to a certain date.

16. A method according to claim 14, wherein the buyer enables a purchase only after a certain time from the previous purchase.

17. A method according to claim 8, wherein the request for a temporary code number is done telephonically.

18. A method according to claim 8, wherein the request for a temporary code number is done by sending an SMS.

19. A method according to claim 8, wherein whenever a wrong master code is entered and sent more than a predetermined amount of times, automatically blocking the card device.

20. A method according to claim 8, wherein the buyer types the sum of the purchase he wishes to make on the device card, along with the master code number and transmits them to the credit card company, to thereby receive the temporary code enabling transaction for this purchase only for said sum.

21. A method according to claim 8, wherein purchasing can be accomplished in a standing order fashion, wherein the temporary code number is needed in the beginning for starting the process of standing order payments.

22. A method according to claim 8, wherein the user signals about a distress condition by inputting and transmitting the master code number in an opposite direction.
